(19) United States
(12) Patent Application Publication
(10) Pub. No.: US 2025/0056579 A1
(43) Pub. Date: Feb. 13, 2025

(54) COMMUNICATION TERMINAL, BASE STATION, TERMINAL PROGRAM, BASE PROGRAM, COMMUNICATION SYSTEM, AND COMMUNICATION METHOD

(71) Applicant: SHARP KABUSHIKI KAISHA, Sakai City, Osaka (JP)

(72) Inventors: Kohei MICHIGAMI, Sakai City, Osaka (JP); Takahisa TANAKA, Sakai City, Osaka (JP); YUHSUKE TAKAGI, Sakai City, Osaka (JP); Tadashi AOKI, Sakai City, Osaka (JP); HIROKAZU KOBAYASHI, Sakai City, Osaka (JP)

(21) Appl. No.: 18/718,034

(22) PCT Filed: Oct. 14, 2022
(86) PCT No.: PCT/JP2022/038285

§ 371 Date: Jun. 8, 2024

(30) Foreign Application Priority Data
Dec. 10, 2021 (JP) 2021-200556

(51) Int. Cl. H04W 72/30; H04W 4/90

(52) U.S. Cl. CPC H04W 72/30; H04W 4/90

(57) ABSTRACT

A communication terminal includes a terminal communicator configured to perform radio communication with a base station, and a terminal controller configured to control the terminal communicator. The terminal controller causes the terminal communicator to transmit a first message of the radio communication to the base station without including, in the first message, specific terminal information indicating that the communication terminal is a specific communication terminal use of which is possibly restricted by the base station, receives a second message as a response to the first message from the base station via the terminal communicator, includes the specific terminal information in a subsequent message that is a third message or is a message subsequent to the third message as a response to the second message, and causes the terminal communicator to transmit the subsequent message to the base station.

### TECHNICAL FIELD

The present disclosure relates to a communication terminal, a base station, a terminal program, a base program, a communication system, and a communication method.

### BACKGROUND ART

In the Third Generation Partnership Project (3GPP) (trade name), use of various communication terminals such as Internet of Things (IoT) devices has been currently studied. For this reason, RedCap, which is a standard for partially restricting New Radio (NR) functions of some specific communication terminals among communication terminals, has been studied.

Examples of the restriction by Reduced Capability (RedCap) include a restriction on the available bandwidth of a specific communication terminal. It is also conceivable that the number of antennas allocated by a base station having a Multi Input Multi Output (MIMO) function to a specific communication terminal is restricted by RedCap. Furthermore, it is conceivable that the communication speed of a specific communication terminal is restricted by RedCap.

Note that the specific communication terminal is referred to as, for example, a RedCap User Equipment (UE). The RedCap UE is a communication terminal desired to be restricted in use of its communication function in a case that an emergency situation occurs since the RedCap UE is expected to be connected to a large number of UEs such as IoT devices.

In addition, in the Third Generation Partnership Project (3GPP), an Early Indication function is discussed. The Early Indication function is a function of notifying a NetWork (NW) that a communication terminal is a specific communication terminal by using messages in Random Access Channel (RACH) processing first performed for the communication terminal to communicate with a base station.

Thus, the communication terminal transmits, to the base station, a message including specific terminal information indicating that the communication terminal is a specific communication terminal, for example, RedCap information. Thereby, the base station can recognize that the communication terminal is a specific communication terminal, for example, a RedCap UE. As a result, the base station performs, for example, the following processing operations described in (1) and (2).
(1) Performing configuration for restricting a communication function of a RedCap UE in a network.
(2) In a case that an emergency situation such as a disaster occurs, performing processing of cutting off, at an early stage, communication with a RedCap UE that has requested connection to the base station in order to reduce a network load.

The reason why the above processing described in (2) is performed is that, in a case that an emergency situation occurs, communication between a UE having a high degree of urgency and the base station may be blocked by a RedCap UE connected to a large number of UEs.

### CITATION LIST

### Patent Literature

PTL 1: WO 2021/161622 A1

### SUMMARY OF INVENTION

### Technical Problem

In the current situation, for example, in a case that an emergency situation due to a disaster such as an earthquake occurs, a base station uniformly rejects connection with RedCap UEs. Thus, even a special-purpose RedCap UE highly required to be connected to a base station in a case that an emergency situation occurs cannot be connected to the base station. Conceivable examples of the special-purpose RedCap UE include a mobile phone used by a rescuer performing a rescue operation for a victim and a wearable device transmitting vital information of an injured person or a sick person.

That is, in a case that communication of a normal RedCap UE is restricted due to an emergency situation, the above-described special-purpose RedCap UE is not allowed to use its communication function even for safety confirmation, life support, or the like.

The present disclosure has been made in view of the above-described problem. An object of the present disclosure is to enable a specific communication terminal to use a communication function of the specific communication terminal even in an emergency state. The present specification discloses a communication terminal, a base station, a terminal program, a base program, a communication system including them, and a communication method using them that can achieve such an object.

### Solution to Problem

A communication terminal according to the present disclosure is a communication terminal including a terminal communicator configured to perform radio communication with a base station, and a terminal controller configured to control the terminal communicator, wherein the terminal controller causes the terminal communicator to transmit a first message of the radio communication to the base station without including, in the first message, specific terminal information indicating that the communication terminal is a specific communication terminal use of which is possibly restricted by the base station, receives a second message as a response to the first message from the base station via the terminal communicator, and includes the specific terminal information in a subsequent message that is a third message or is a message subsequent to the third message as a response to the second message and causes the terminal communicator to transmit the subsequent message to the base station.

A base station according to the present disclosure is a base station including a base communicator configured to perform radio communication with a communication terminal, and a base controller configured to control the base communicator, wherein the base controller receives a first message of the radio communication from the communication terminal via the base communicator, causes the base communicator to transmit a second message to the communication terminal as a response to the first message in a case that the first message does not include specific terminal information indicating that the communication terminal is a specific communication terminal use of which is possibly restricted by the base station, receives, from the communication terminal, a subsequent message that is a third message or is a message subsequent to the third message as a response to the second message, and causes the communication terminal to use a communication function as the specific communication terminal in a case that the specific terminal information is included in the subsequent message.

A terminal program according to the present disclosure is a computer-readable terminal program for causing a computer to operate, in a communication terminal, as a terminal controller controlling a terminal communicator performing radio communication with a base station, wherein the terminal controller causes the terminal communicator to transmit a first message of the radio communication to the base station without including, in the first message, specific terminal information indicating that the communication terminal is a specific communication terminal use of which is possibly restricted by the base station, receives a second message as a response to the first message from the base station via the terminal communicator, and includes the specific terminal information in a subsequent message that is a third message or is a message subsequent to the third message as a response to the second message and causes the terminal communicator to transmit the subsequent message to the base station.

A base program according to the present disclosure is a computer-readable base program for causing a computer to operate, in a base station, as a base controller controlling a base communicator performing radio communication with a communication terminal, wherein the base controller receives a first message of the radio communication from the communication terminal via the base communicator, causes the base communicator to transmit a second message to the communication terminal as a response to the first message in a case that the first message does not include specific terminal information indicating that the communication terminal is a specific communication terminal use of which is possibly restricted by the base station, receives, from the communication terminal, a subsequent message that is a third message or is a message subsequent to the third message as a response to the second message, and causes the communication terminal to use a communication function as the specific communication terminal in a case that the specific terminal information is included in the subsequent message.

A communication system according to the present disclosure is a communication system including a communication terminal, and a base station configured to perform radio communication with the communication terminal, wherein the communication terminal transmits a first message of the radio communication to the base station without including, in the first message, specific terminal information indicating that the communication terminal is a specific communication terminal use of which is possibly restricted by the base station, the base station receives the first message from the communication terminal and transmits a second message to the communication terminal as a response to the first message, the communication terminal receives the second message from the base station, includes the specific terminal information in a subsequent message that is a third message or is a message subsequent to the third message as a response to the second message, and transmits the subsequent message to the base station, and the base station receives the subsequent message from the communication terminal and causes the communication terminal to use a communication function as the specific communication terminal in a case that the specific terminal information is included in the subsequent message.

A communication method according to the present disclosure is a communication method between a communication terminal and a base station performing radio communication with the communication terminal, wherein the communication terminal transmits a first message of the radio communication to the base station without including, in the first message, specific terminal information indicating that the communication terminal is a specific communication terminal use of which is possibly restricted by the base station, the base station receives the first message from the communication terminal and transmits a second message to the communication terminal as a response to the first message, the communication terminal receives the second message from the base station, includes the specific terminal information in a subsequent message that is a third message or is a message subsequent to the third message as a response to the second message, and transmits the subsequent message to the base station, and the base station receives the subsequent message from the communication terminal and causes the communication terminal to use a communication function as the specific communication terminal in a case that the specific terminal information is included in the subsequent message.

### BRIEF DESCRIPTION OF DRAWINGS

FIG. 1 is a schematic diagram illustrating communication systems and a network according to an embodiment.

FIG. 2 is a block diagram illustrating an internal configuration of each of a communication terminal and a base station constituting a communication system according to an embodiment.

FIG. 3 is a sequence diagram for describing a mode of transmission and/or reception of messages in an emergency state between a communication terminal and a base station constituting a communication system according to an embodiment.

FIG. 4 is a schematic diagram for describing a communication terminal capable of communicating with a base station in an emergency state and communication terminals incapable of communicating with the base station in the emergency state in a communication system according to an embodiment.

FIG. 5 is a sequence diagram for describing a mode of transmission and/or reception of messages in an emergency state between a communication terminal and a base station constituting a communication system according to a comparative example.

FIG. 6 is a schematic diagram for describing communication terminals incapable of communicating with a base station in an emergency state of a communication system according to a comparative example.

FIG. 7 is a flowchart for describing processing performed by a terminal controller of a communication terminal of a communication system according to an embodiment.

FIG. 8 is a flowchart for describing processing performed by a base controller of a base station of a communication system according to an embodiment.

### DESCRIPTION OF EMBODIMENTS

Hereinafter, a communication terminal, a base station, a terminal program, a base program, a communication system including them, and a communication method using them according to an embodiment of the present disclosure will be described with reference to the drawings. Note that, in the drawings, the same or equivalent elements are denoted by the same reference numerals and duplicate description thereof will be omitted.

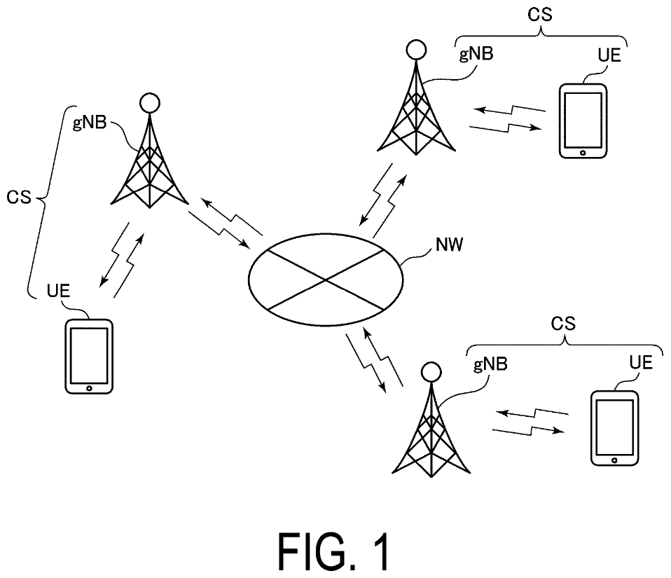

FIG. 1 is a schematic diagram illustrating communication systems CS and a network NW according to an embodiment.

As illustrated in FIG. 1, base stations gNB constituting the communication systems CS are connected to each other via the network NW so as to be able to perform wireless or wired communication. Each of the communication systems CS includes a communication terminal UE and a corresponding one of the base stations gNB. The communication terminal UE and the base station gNB are connected in a wirelessly communicable manner. The network NW is an electric information communication network called the Internet in the present embodiment, but may be another electric information communication network.

The communication terminal UE is a RedCap UE, which is an example of a specific communication terminal conforming to the standard of the Fifth Generation (5G) mobile communication system. However, the communication terminal UE may conform to a standard other than the standard of the 5G mobile communication system, such as the standard of the 3G, 4G, or 6G mobile communication system. The communication terminal UE is, for example, a mobile terminal such as a smartphone. However, the communication terminal UE may be any communication device, such as so-called Internet of Things (IoT), that can communicate with the base station gNB in the communication system CS. The communication terminal UE may be, for example, any of a monitoring camera, a sensor, a wearable device, and the like that can communicate with the base station gNB as long as the communication terminal UE is a RedCap UE use of which is possibly restricted by the base station gNB in an emergency state.

The base station gNB (next generation Node B) is a base station conforming to the standard of the 5G mobile communication system. The base station gNB is a base station newly designed for the 5G communication system and has a function different from that of a base station eNB (evolved Node B) used in an EPS, which is a 4G communication system. However, the base station gNB may conform to a standard other than the standard of the 5G mobile communication system such as the standard of the 3G, 4G, or 6G mobile communication system.

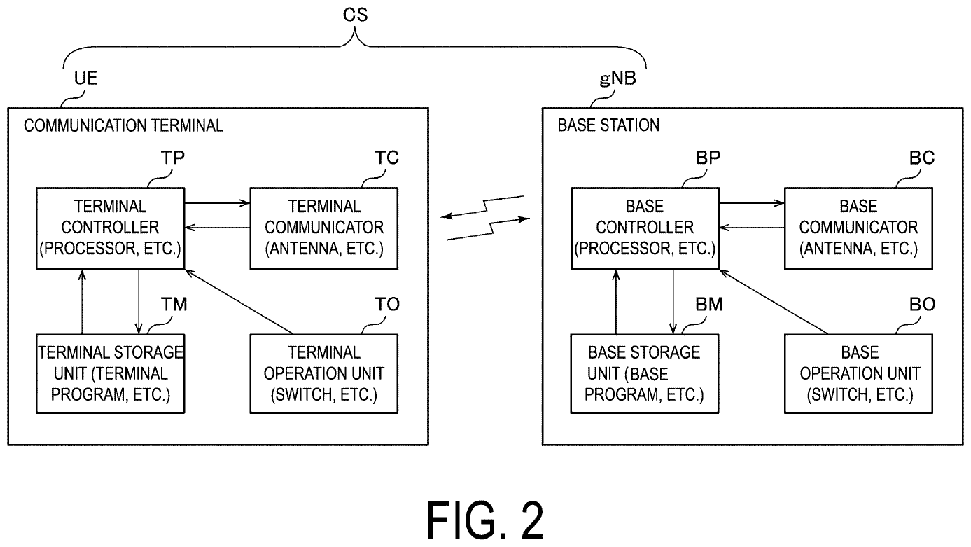

FIG. 2 is a block diagram illustrating an internal configuration of each of the communication terminal UE and the base station gNB constituting the communication system CS according to the embodiment.

As illustrated in FIG. 2, the communication terminal UE includes a terminal communicator TC, a terminal operation unit TO, a terminal storage unit TM, and a terminal controller TP.

The terminal communicator TC receives a message transmitted from the base station gNB and transmits the received message to the terminal controller TP. The terminal communicator TC includes at least one antenna.

The terminal operation unit TO has a function as a switch operated by a user who uses the communication terminal UE. The terminal operation unit TO transmits a signal based on the operation to the terminal controller TP. The terminal operation unit TO may be any unit such as a physical push-button switch or an icon displayed on a touch pad as long as the terminal operation unit TO can transmit a signal indicating that the current state is an emergency state to the terminal controller TP by being operated by the user.

The terminal storage unit TM stores a terminal program for causing the terminal controller TC to perform various types of processing. The terminal storage unit TM is a non-transitory tangible storage medium. The terminal storage unit TM may be any type of memory such as a Random Access Memory (RAM) and a Read Only Memory (ROM).

The terminal controller TP performs the following processing based on the terminal program stored in the terminal storage unit TM. The terminal controller TP performs processing of receiving a message transmitted from the base station gNB via the terminal communicator TC. The terminal controller TP performs processing of generating a response message to the received message. The terminal controller TP performs processing of causing the terminal communicator TC to transmit the response message to the communication terminal UE. The terminal controller TP is built in hardware called a computer and includes a processor capable of reading the terminal program by the computer.

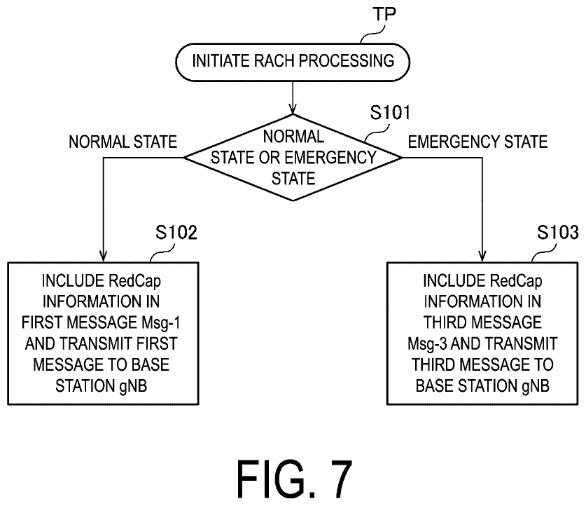

In the present embodiment, the communication terminal UE includes the terminal operation unit TO operated by the user. In a case that the user performs a predetermined operation, the terminal operation unit TO transmits, to the terminal controller TC, state information indicating whether the current state is a normal state or an emergency state. However, the communication terminal UE does not need to include the terminal operation unit TO. In this case, the terminal controller TP receives state information indicating whether the current state is a normal state or an emergency state, for example, information that indicates an emergency state such as a disaster and that is transmitted by the government, from outside the terminal apparatus UE via the terminal communicator TC. Note that, in either case, the terminal controller TP performs processing of determining whether the current state is a normal state or an emergency state (see S101 in FIG. 7). However, in a case that the communication terminal UE is configured to be always used in a mode of the emergency state, that is, in a case that the communication terminal UE is not used in a mode of the normal state, the terminal controller TP does not need the processing of determining whether the current state is a normal state or an emergency state.

The emergency state is a state in which a disaster such as an earthquake, fire, tsunami, or explosion accident occurs and thus an extremely large number of communication terminals UE are expected to perform communication via one base station gNB. The emergency state is also a state in which an event such as a firework festival or concert in which many people gather is held and thus an extremely large number of communication terminals UE are expected to perform communication via one base station gNB. In such an emergency state, the network NW may have a communication failure, or the like in a case that all the communication terminals UE attempting to communicate with other communication terminals UE via the one base station gNB use their communication functions. Thus, the base station gNB preferably does not allow a specific communication terminal such as a RedCap UE to use a communication function as the specific communication terminal in the emergency state. Specifically, the base station gNB preferably rejects connection of the specific communication terminal to the base station gNB.

However, as described above, some specific communication terminals are preferably allowed to use functions of the specific communication terminals via the network NW even in the emergency state. Thus, the communication terminal UE, which is the specific communication terminal according to the present embodiment, is configured to be able to use a function of the specific communication terminal even in the emergency state. Further, the base station gNB according to the present embodiment is configured to allow the communication terminal UE, which is the specific communication terminal, to use a function of the specific communication terminal even in the emergency state.

On the other hand, the normal state is a state other than the above-described emergency state. Thus, the normal state is a state in which the base station gNB allows the communication terminal UE to use a communication function thereof, regardless of whether the communication terminal UE is a specific communication terminal or a normal communication terminal, which is not the specific communication terminal. More specifically, in a case that the communication terminal UE is not a specific communication terminal but a normal communication terminal, the base station gNB is configured to allow the communication terminal UE to use a communication function as the normal communication terminal in the normal state. Further, in a case that the communication terminal UE is a specific communication terminal, the base station gNB is configured to allow the communication terminal UE to use a communication function as the specific communication terminal.

The base station gNB includes a base communicator BC, a base storage unit BM, a base operation unit BO, and a base controller BP.

The base communicator BC receives a message transmitted from the communication terminal UE and transmits the received message to the base controller BP. The base communicator BC includes at least one antenna.

The base operation unit BO has a function as a switch operated by a user who manages the base station gNB. The base operation unit BO transmits a signal based on the operation to the base controller BP. The base operation unit BO may be any unit such as a physical push-button switch or an icon displayed on a touch pad as long as the base operation unit BO can transmit a predetermined signal, for example, a signal indicating that the current state is an emergency state to the base controller BP by being operated by the user.

The base storage unit BM stores a base program for causing the base controller BP to perform various types of processing. The base storage unit BM is a non-transitory tangible storage medium. The base storage unit BM may be any type of memory such as a RAM and ROM.

The base controller BP performs the following processing based on the base program stored in the base storage unit BM. The base controller BP performs processing of receiving a message transmitted from the communication terminal UE via the base communicator BC. The base controller BP performs processing of generating a response message to the received message. The base controller BP performs processing of causing the base communicator BC to transmit the response message to the communication terminal UE. The base controller BP is built in hardware called a computer and includes a processor capable of reading the base program by the computer.

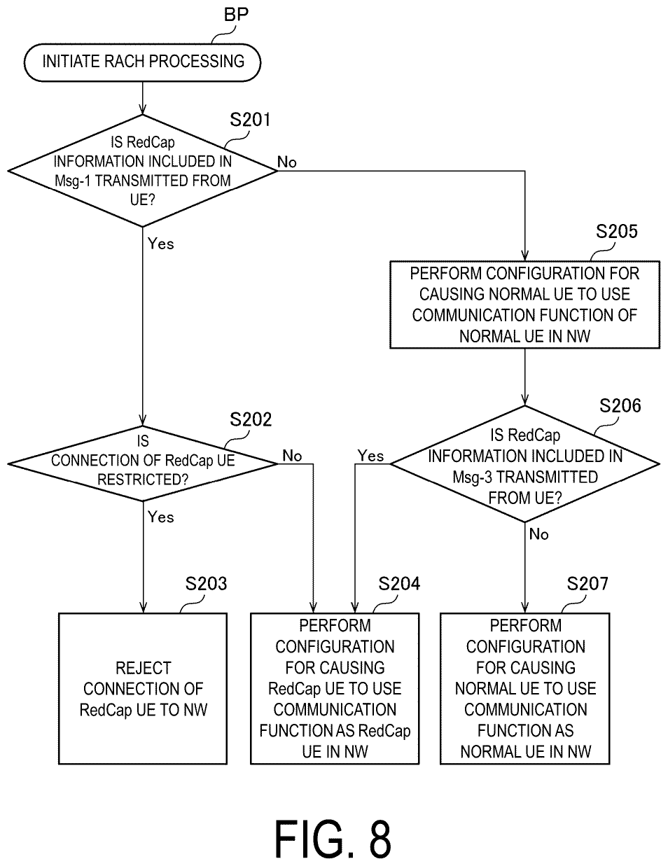

In the present embodiment, the base station gNB includes the base operation unit BO operated by the user. In a case that the user performs a predetermined operation, the base operation unit BO transmits, to the base controller BP, state information indicating whether the current state is a normal state or an emergency state. However, the base station gNB does not need to include the base operation unit BO. In this case, the base controller BP receives state information indicating whether the current state is a normal state or an emergency state, for example, information that indicates an emergency state such as a disaster and that is transmitted by the government, from outside the base station gNB via the base communicator BC. Note that, in either case, the base controller BP determines whether the current state is a normal state or an emergency state (see S202 in FIG. 8).

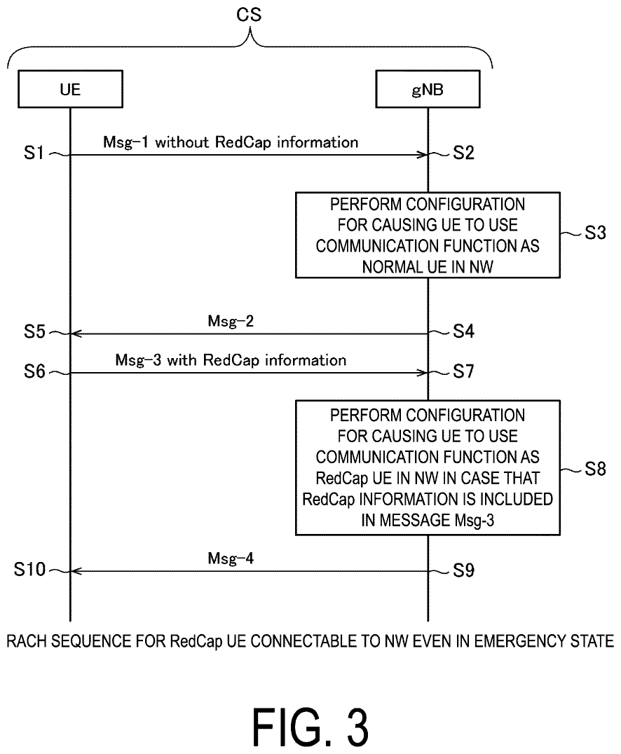

FIG. 3 is a sequence diagram for describing a mode of transmission and/or reception of messages in an emergency state between the communication terminal UE and the base station gNB constituting the communication system CS according to the embodiment.

In the communication system CS according to the present embodiment, the communication terminal UE transmits a first message Msg-1 to the base station gNB in step S1. At this time, the communication terminal UE does not include specific terminal information in the first message Msg-1 of radio communication. This specific terminal information is information indicating that the communication terminal UE is a specific communication terminal use of which is possibly restricted by the base station gNB. In addition, the specific terminal information is also information indicating that a communication function of the specific communication terminal is partially restricted as compared with a communication function of a normal communication terminal.

The specific terminal information indicates, for example, that the specific communication terminal uses a bandwidth equal to or less than a predetermined value. However, the specific terminal information may indicate that the communication speed of the specific communication terminal is equal to or lower than a predetermined value. Further, the specific terminal information may indicate that the number of antennas allocated by the base station to the specific communication terminal is smaller than the number of antennas allocated to the normal communication terminal.

In the present embodiment, the specific communication terminal is a RedCap UE defined in the 5G communication standard. The bandwidth equal to or less than the predetermined value is a RedCap bandwidth defined in the 5G communication standard. The specific terminal information is RedCap information defined in the 5G communication standard.

In step S2, the base station gNB receives the first message Msg-1 from the communication terminal UE. In step S3, the base station gNB performs configuration for causing the communication terminal UE to use a communication function as a normal communication terminal, i.e., a normal UE in the network NW. The normal communication terminal is a communication terminal that is not a specific communication terminal. Thereafter, in step S4, the base station gNB transmits, to the communication terminal UE, a second message Msg-2 as a response to the first message Msg-1.

In step S5, the communication terminal UE receives the second message Msg-2 from the base station gNB. In step S6, the communication terminal UE includes the above-described specific terminal information in a third message Msg-3 as a response to the second message Msg-2 and transmits the third message Msg-3 to the base station gNB. However, the communication terminal UE may include the above-described specific terminal information in a subsequent message subsequent to the third message Msg-3, for example, a fifth message Msg-5.

Next, in step S7, the base station gNB receives the third message Msg-3 including the specific terminal information from the communication terminal UE. In step S8, in a case that the specific terminal information is included in the third message Msg-3, the base station gNB performs configuration for causing the communication terminal UE to use a communication function as a specific communication terminal in the network NW even in a case that the current state is an emergency state. However, in a case that the specific terminal information is included in the subsequent message subsequent to the third message, for example, the fifth message Msg-5, the base station gNB may perform configuration for causing the communication terminal UE to use a communication function as a specific communication terminal in the network NW. In step S9, the base station gNB transmits, to the communication terminal UE, a fourth message Msg-4 as a response to the third message Msg-3. In step S10, the communication terminal UE receives the fourth message Msg-4.

Note that, in the case that the specific terminal information is included in the subsequent message subsequent to the third message Msg-3, for example, the fifth message Msg-5 (not illustrated), the base station gNB also performs similar processing to that in step S7 to step S9.

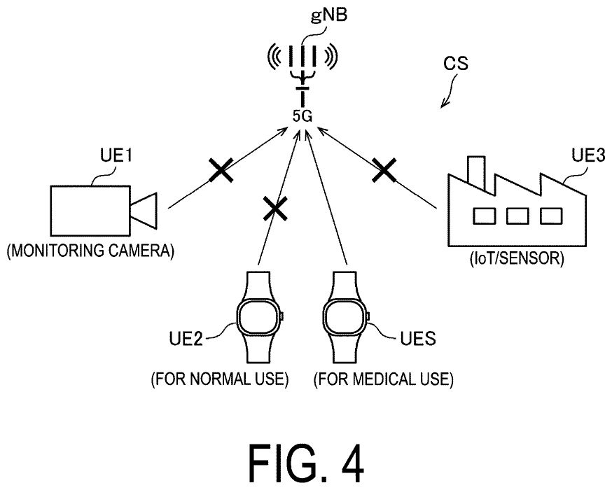

FIG. 4 is a schematic diagram for describing a communication terminal UE capable of communicating with the base station gNB in an emergency state and communication terminals UE incapable of communicating with the base station gNB in the emergency state in the communication system CS according to the embodiment.

As can be seen from FIG. 4, communication terminals UE1, UE2, UE3 and UES are connected to the base station gNB. The communication terminal UE1 has a monitoring camera function. The communication terminal UE2 is a wearable device and has a function similar to that of a normal smartphone. The communication terminal UE3 is a sensor or an IoT device in a factory. The communication terminal UES is a wearable device and has a function of acquiring vital information for human medical care and transmitting the information to the base station gNB. The communication terminals UE1, UE2, UE3, and UES are all RedCap UEs. The communication terminals UE1, UE2 and UE3 are communication terminals less required to be connected to the base station gNB in an emergency state. Thus, the communication terminals UE1, UE2, and UE3 are configured to include RedCap information in a first message Msg-1. On the other hand, since the communication terminal UES is a communication terminal that transmits medical vital information, the communication terminal UES is preferably connectable to the base station gNB even in an emergency state. Thus, as described with reference to FIG. 3, the communication terminal UES is configured to include RedCap information not in a first message Msg-1 but in a third message Msg-3.

As can be seen from FIG. 4, for example, the communication terminal UES that transmits medical vital information can communicate with the base station gNB by the communication method described with reference to FIG. 3 even in a case that use of a RedCap UE is restricted in an emergency state. That is, the communication terminal UES can communicate with another communication terminal via the network NW by using a communication function as a RedCap UE. On the other hand, since use of a RedCap UE is restricted in an emergency state, each of the communication terminals UE1, UE2, and UE3 cannot communicate with the base station gNB. That is, each of the communication terminals UE1, UE2, and UE3 cannot communicate with another communication terminal via the network NW by using a communication function as a RedCap UE.

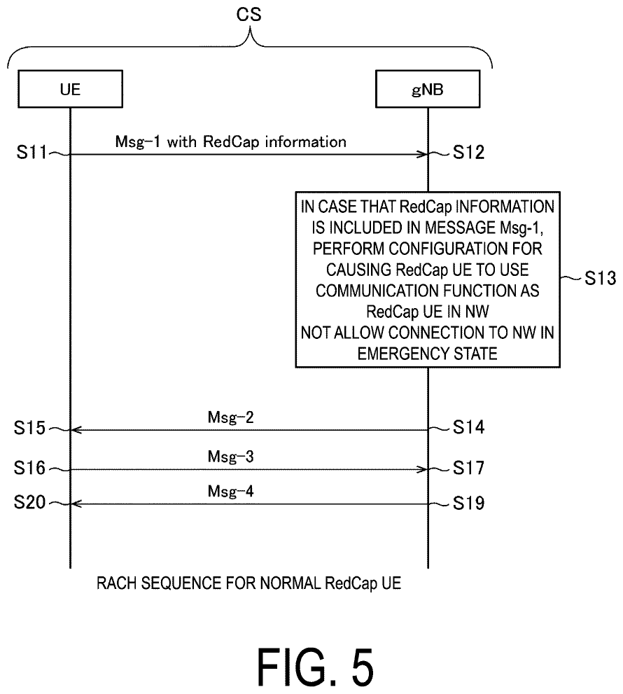

FIG. 5 is a sequence diagram for describing a mode of transmission and/or reception of messages in an emergency state between a communication terminal UE and a base station gNB constituting a communication system CS according to a comparative example.

As can be seen from FIG. 5, in step S11, the communication terminal UE includes specific terminal information, for example, RedCap information in a first message Msg-1 and transmits the first message Msg-1 to the base station gNB. In step S12, the base station gNB receives the first message Msg-1. In step S13, in a case that the current state is a normal state, the base station gNB performs configuration for causing the communication terminal UE, which is a RedCap UE, to use a communication function as the RedCap UE. Thereafter, in step S14, the base station gNB transmits a second message Msg-2 to the communication terminal UE.

Thus, the communication system according to the comparative example illustrated in FIG. 5 enables the communication terminal UE as a RedCap UE to receive the second message Msg-2 in step S15 in a case that the current state is a normal state. Further, the base station gNB receives a third message Msg-3 in step S17 and transmits a fourth message Msg-4 in step S19. Thus, the communication terminal UE as a RedCap UE can transmit the third message Msg-3 to the base station gNB in step S16 and receive the fourth message Msg-4 in step S20.

On the other hand, in step 13, the communication terminal UE that has transmitted the first message Msg-1 including the RedCap information is rejected in a case that the current state is an emergency state. In this case, the base station gNB does not transmit the second message Msg-2 in step S14 to the communication terminal UE or transmit, to the communication terminal UE, a message indicating rejection of communication with the communication terminal UE, instead of the second message Msg-2 in step S14. Thus, in a case that the current state is an emergency state, the communication terminal UE as a RedCap UE cannot transmit the third message Msg-3 in step S16 illustrated in FIG. 5 to the base station gNB. That is, since connection of the communication terminal UE is rejected by the base station gNB, the communication terminal UE cannot use a function as a RedCap UE. Note that, in this case as well, a normal communication terminal, which is not a RedCap UE, can communicate with the base station gNB.

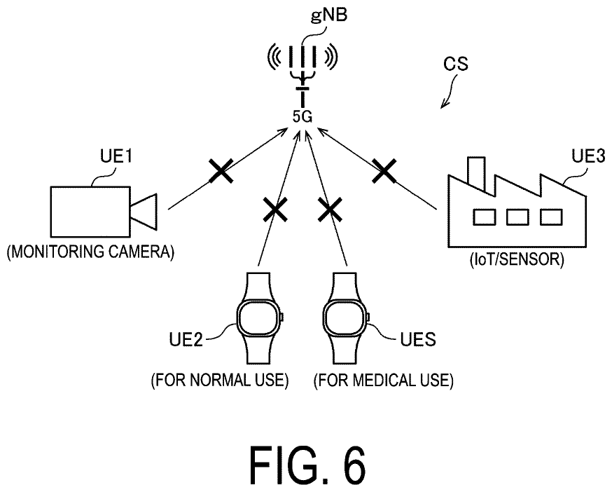

FIG. 6 is a schematic diagram for describing a communication terminal UE capable of communicating with the base station gNB in an emergency state and a communication terminal UE incapable of communicating with the base station gNB in the emergency state in the communication system CS according to the comparative example.

Communication terminals UE1, UE2, UE3, and UES illustrated in FIG. 6 are all specific communication terminals, for example, RedCap UEs, in a manner similar to those illustrated in FIG. 4.

As can be seen from FIG. 6, according to the communication method described with reference to FIG. 5, not only the communication terminals UE1, UE2, and UE3 but also the communication terminal UES transmitting medical vital information cannot communicate with the base station gNB in an emergency state. Thus, since the medical vital information cannot be used in the emergency state, a situation in which appropriate medical care cannot be performed may occur.

That is, according to the communication method of FIG. 5, none of the communication terminals UE, UE2, UE3, and UES as RedCap UEs can communicate with other communication terminals via the base station gNB and the network NW in an emergency state.

As described above, unlike the communication method according to the comparative example of FIGS. 5 and 6, the communication method of FIGS. 3 and 4 enables the communication terminal UE as a RedCap UE to use a communication function as the RedCap UE even in a case that the current state is an emergency state.

FIG. 7 is a flowchart for describing processing performed by the terminal controller TP of the communication terminal UE of the communication system CS according to the embodiment. The processing illustrated in FIG. 7 is Random Access Channel (RACH) processing first performed for the communication terminal UE to communicate with the base station gNB in the 5G mobile communication system.

In step S101, the terminal controller TP of the communication terminal UE determines whether the current state is a normal state or an emergency state.

In the present embodiment, the user determines whether the current state is a normal state or an emergency state based on disaster information or the like notified by the government. Thus, by operating the terminal operation unit TO, state information indicating whether the current state is a normal state or an emergency state is transmitted to the terminal controller TP. Accordingly, whether to use a communication function as a RedCap UE in an emergency state can be selected by the user of the RedCap UE.

However, the terminal controller TP may automatically determine whether the current state is a normal state or an emergency state based on, for example, the disaster information or the like notified by the government as described above. In this case, in step S101, the terminal controller TC receives the state information indicating whether the current state is a normal state or an emergency state from outside the communication terminal UE via the terminal communicator TC.

In a case that it is determined in step S101 that the current state is a normal state, the terminal controller TP includes RedCap information in a first message Msg-1 and causes the terminal communicator TC to transmit the first message Msg-1 to the base station gNB in step S102. On the other hand, in a case that it is determined in step S101 that the current state is an emergency state, the terminal controller TP includes the RedCap information in a third message Msg-3 and causes the terminal communicator TC to transmit the third message Msg-3 to the base station gNB in step S103.

However, the terminal controller TP of the communication terminal UE may always include the RedCap information in the third message Msg-3 and transmit the third message Msg-3 to the base station gNB without performing the determination processing illustrated in FIG. 7. Accordingly, the user of the RedCap UE can always use a communication function as the RedCap UE in an emergency state without changing any configuration of the communication terminal UE.

FIG. 8 is a flowchart for describing processing performed by the base controller BP of the base station gNB of the communication system CS according to the embodiment. The processing illustrated in FIG. 8 is RACH processing first performed for the base station gNB to communicate with the communication terminal UE in the standard of the 5G mobile communication system.

In step S201, the base controller BP determines whether specific terminal information, for example, RedCap information is included in a first message Msg-1 transmitted from the communication terminal UE and received by the base communicator BC. In a case that it is determined in step S201 that the specific terminal information is included in the first message Msg-1, the base controller BP determines in step S202 whether the current state is a normal state or an emergency state. Specifically, the base controller BP determines whether connection of the communication terminal UE as a specific communication terminal, for example, a RedCap UE, to the network NW is restricted.

In the present embodiment, for example, the user determines whether the current state is a normal state or an emergency state based on disaster information or the like notified by the government. Thus, by operating the base operation unit BO, state information indicating a normal state or an emergency state is transmitted to the base controller BP.

However, the base controller BP may automatically determine whether the current state is a normal state or an emergency state based on, for example, the disaster information notified by the government as described above. In this case, in step S202, the base controller BP receives the state information indicating whether the current state is a normal state or an emergency state from outside the base station gNB via the base communicator BC.

In a case that the current state is an emergency state in step S202, the base controller BP causes the communication terminal UE not to use a communication function as a specific communication terminal in step S203. More specifically, in a case that connection of the specific communication terminal to the network NW is restricted in step S202, the base controller BP rejects connection of the communication terminal UE as a RedCap UE to the network NW in step S203. Thus, the communication terminal UE cannot communicate with another communication terminal or the like via the base station gNB.

On the other hand, in a case that the current state is a normal state in step S202, the base controller BP performs configuration for causing the communication terminal UE to use a communication function as a specific communication terminal in step S204. More specifically, in the case that connection of the specific communication terminal is not restricted in step S202, the base controller BP performs configuration for causing the communication terminal UE to use a communication function as a RedCap UE in step S204. Thereby, the communication terminal UE as a RedCap UE can communicate with another communication terminal via the base station gNB.

In a case that it is determined in step S201 that the specific terminal information is not included in the first message Msg-1, the base controller BP performs configuration for causing the communication terminal UE to use a communication function as a normal communication terminal in step S205. More specifically, in a case that it is determined that the RedCap information is not included in the first message Msg-1, the base controller BP performs configuration for causing the communication terminal UE to use a communication function as a normal communication terminal in step S205. Thus, the base controller BP causes the base communicator BT to transmit a message Msg-2 to the communication terminal UE. Thereafter, the base controller BP receives a third message Msg-3 from the communication terminal UE. Accordingly, the base controller BP determines in step S206 whether the specific terminal information is included in the third message Msg-3 received by the base communicator BT.

In a case that it is determined in step S206 that the specific terminal information is included in the third message Msg-3, the base controller BP performs configuration for causing the communication terminal UE to use a communication function as a RedCap UE in step S204. Thereby, the communication terminal UE as a RedCap UE can communicate with another communication terminal or the like via the base station gNB. On the other hand, in a case that it is determined in step S206 that the specific terminal information is not included in the third message Msg-3, the base controller BP continues the configuration for causing the communication terminal UE to use a communication function as a normal communication terminal in step S207. Thus, the base controller BP causes the base communicator BT to transmit a message Msg-4 to the communication terminal UE.

The characteristic configuration of the communication method by the communication system CS according to the above-described embodiment is as follows.

(1) The communication terminal UE includes the terminal communicator TC configured to perform radio communication with the base station gNB and the terminal controller TP configured to control the terminal communicator. The terminal controller TP causes the terminal communicator TC to transmit a first message Msg of the radio communication to the base station gNB without including, in the first message Msg-1, specific terminal information indicating that the communication terminal UE is a specific communication terminal use of which is possibly restricted by the base station gNB. The terminal controller TP receives a second message Msg-2 as a response to the first message Msg-1 from the base station gNB via the terminal communicator TC. The terminal controller TP includes the specific terminal information in a subsequent message that is a third message Msg-3 or is a message subsequent to the third message Msg-3 as a response to the second message Msg-2 and causes the terminal communicator TC to transmit the subsequent message to the base station gNB. According to this, since the first message Msg-1 does not include the specific terminal information, connection is not rejected by the base station gNB that rejects connection with the communication terminal UE in a case that the specific terminal information is included in the first message Msg-1. Thus, the communication terminal UE can use a communication function of the specific communication terminal even in an emergency state.

(2) The terminal controller TP determines whether the current state is a normal state or an emergency state different from the normal state. In the normal state, the terminal controller TP includes the specific terminal information in the first message Msg-1 and causes the terminal communicator TC to transmit the first message Msg-1 to the base station gNB. On the other hand, in the emergency state, the terminal controller TP includes the specific terminal information in the subsequent message and causes the terminal communicator TC to transmit the subsequent message to the base station gNB. According to this, the communication terminal UE is switched to a use mode used in the normal state or a use mode used in the emergency state.

(3) The communication terminal UE further includes the terminal operation unit TO operated by a user. In a case that the user performs a predetermined operation, the terminal operation unit TO transmits, to the terminal controller TP, state information indicating whether the current state is the normal state or the emergency state. According to this, the user of the communication terminal UE can configure the normal state or the emergency state as the current state of the communication terminal UE by himself/herself. Thus, the user of the communication terminal UE can select whether to use a communication function as the communication terminal UE, which is the specific communication terminal, in the emergency state according to his/her own determination.

(4) The terminal controller TP receives the state information indicating the normal state or the emergency state from outside the communication terminal UE via the terminal communicator TC. According to this, the terminal controller TP can automatically identify whether the current state is the normal state or the emergency state without the user's determination. As a result, the communication terminal UE is automatically switched to a use mode of the normal state or a use mode of the emergency state without the user's determination.

(5) The specific terminal information is information indicating that the communication function of the specific communication terminal is partially restricted as compared with a communication function of a normal communication terminal, which is not the specific communication terminal. Even in a case that the communication terminal UE is the specific communication terminal partially restricted in the communication function as compared with the communication function of the normal communication terminal, the user of the communication terminal UE can use the communication function of the specific communication terminal in the emergency state.

(6) The base station gNB includes the base communicator BC configured to perform radio communication with the communication terminal UE and the base controller BP configured to control the base communicator BC. The base controller BP receives a first message Msg-1 of the radio communication from the communication terminal UE via the base communicator BC. The first message Msg-1 may not include specific terminal information indicating that the communication terminal UE is a specific communication terminal use of which is possibly restricted by the base station gNB. In this case, the base controller BP causes the base communicator PC to transmit a second message Msg-2 to the communication terminal UE as a response to the first message Msg-1. The base controller BP receives, from the communication terminal UE, a subsequent message that is a third message Msg-3 or is a message subsequent to the third message Msg-3 as a response to the second message Msg-2. In a case that the specific terminal information is included in the subsequent message, the base controller BP can cause the communication terminal UE to use a communication function as the specific communication terminal. According to this, the base station gNB can cause the communication terminal UE to use the communication function as the specific communication terminal even in the emergency state.

(7) The base controller BP determines whether the current state is the normal state or the emergency state different from the normal state. In the normal state, the base controller BP causes the communication terminal UE to use the communication function as the specific communication terminal even in a case that the specific terminal information is included in the first message Msg-1. On the other hand, in the emergency state different from the normal state, the base controller BP causes the communication terminal UE not to use the communication function as the specific communication terminal in a case that the specific terminal information is included in the first message Msg-1. In a case that the specific terminal information is included in the subsequent message, the base controller BP causes the communication terminal UE to use the communication function as the specific communication terminal. According to this, the base station gNB is switched to a response mode for the communication terminal UE in the normal state or a response mode for the communication terminal UE in the emergency state.

(8) The base station gNB further includes the base operation unit BO operated by the user. In a case that the user performs a predetermined operation, the base operation unit BO transmits, to the base controller BP, state information indicating whether the current state is the normal state or the emergency state. According to this, the administrator of the base station gNB can select the response mode in the normal state or the response mode in the emergency state as the current state of the base station gNB according to his/her own determination. Thus, the administrator of the base station gNB can select whether to cause the communication terminal UE, which is the specific communication terminal, to use the communication function of the specific communication terminal in the emergency state according to his/her own determination.

(9) The base controller BP receives the state information indicating whether the current state is the current normal state or the emergency state from outside the base station gNB via the base communicator BC. According to this, the base controller BP can automatically identify whether the current state is the normal state or the emergency state without the user's determination. As a result, the response mode of the base station gNB is automatically switched to the response mode in the normal state or the response mode in the emergency state without the user's determination.

(10) In a case that the specific terminal information is not included in the subsequent message, the base controller BP causes the communication terminal UE to use a communication function as a normal communication terminal, which is not the specific communication terminal. According to this, the base station gNB can cause the normal communication terminal, which is not the specific communication terminal, to use the communication function as the normal communication terminal in both the normal state and the emergency state.

(11) The specific terminal information is information indicating that the communication function of the specific communication terminal is partially restricted. Even in a case that the communication terminal UE is the specific communication terminal partially restricted in the communication function as compared with the communication function of the normal communication terminal, which is not the specific communication terminal, the administrator of the base station gNB can cause the communication terminal UE to use the communication function as the specific communication terminal in the emergency state.

(12) The terminal program causes a computer to operate as each unit of the communication terminal UE described above.

(13) The base program causes a computer to operate as each unit of the base station gNB described above.

(14) The communication system CS includes the above-described communication terminal UE and the above-described base station gNB.

(15) The communication method is performed between the above-described communication terminal UE and the above-described base station gNB.

1. A communication terminal comprising:
a terminal communicator configured to perform radio communication with a base station; and
a terminal controller configured to control the terminal communicator, wherein
the terminal controller
causes the terminal communicator to transmit a first message of the radio communication to the base station without including, in the first message, specific terminal information indicating that the communication terminal is a specific communication terminal use of which is possibly restricted by the base station,
receives a second message as a response to the first message from the base station via the terminal communicator, and
includes the specific terminal information in a subsequent message that is a third message or a message subsequent to the third message as a response to the second message, and causes the terminal communicator to transmit the subsequent message to the base station.

2. The communication terminal according to claim 1, wherein
the terminal controller
determines whether a current state is a normal state or an emergency state different from the normal state;
in the normal state, includes the specific terminal information in the first message and causes the terminal communicator to transmit the first message to the base station, and
in the emergency state, includes the specific terminal information in the subsequent message and causes the terminal communicator to transmit the subsequent message to the base station.

3. The communication terminal according to claim 2, further comprising:
a terminal operation unit operated by a user, wherein
in a case that the user performs a predetermined operation, the terminal operation unit transmits, to the terminal controller, state information indicating whether the current state is the normal state or the emergency state.

4. The communication terminal according to claim 2, wherein
the terminal controller receives state information indicating whether the current state is the normal state or the emergency state from outside the communication terminal via the terminal communicator.

5. The communication terminal according to any of claims 1- to 4, wherein
the specific terminal information is information indicating that a communication function of the specific communication terminal is partially restricted as compared with a communication function of a normal communication terminal that is not the specific communication terminal.

6. A base station comprising:
a base communicator configured to perform radio communication with a communication terminal; and
a base controller configured to control the base communicator, wherein
the base controller
receives a first message of the radio communication from the communication terminal via the base communicator,
causes the base communicator to transmit a second message to the communication terminal as a response to the first message in a case that the first message does not include specific terminal information indicating that the communication terminal is a specific communication terminal use of which is possibly restricted by the base station,
receives, from the communication terminal, a subsequent message that is a third message or is a message subsequent to the third message as a response to the second message, and
causes the communication terminal to use a communication function as the specific communication terminal in a case that the specific terminal information is included in the subsequent message.

7. The base station according to claim 6, wherein
the base controller
determines whether a current state is a normal state or an emergency state different from the normal state,
in the normal state, causes the communication terminal to use the communication function as the specific communication terminal even in a case that the specific terminal information is included in the first message, and
in the emergency state, causes the communication terminal not to use the communication function as the specific communication terminal in a case that the specific terminal information is included in the first message, and causes the communication terminal to use the communication function as the specific communication terminal in a case that the specific terminal information is included in the subsequent message.

8. The base station according to claim 7, further comprising:
a base operation unit operated by a user
in a case that the user performs a predetermined operation, the base operation unit transmits, to the base controller, state information indicating whether the current state is the normal state or the emergency state.

9. The base station according to claim 7, wherein
the base controller receives state information indicating whether the current state is the normal state or the emergency state, from outside the base station via the base communicator.

10. The base station according to claim 6, wherein
in a case that the specific terminal information is not included in the subsequent message, the base controller causes the communication terminal to use a communication function as a normal communication terminal that is not the specific communication terminal.

11. The base station according to claim 6, wherein
the specific terminal information is information indicating a communication terminal in which the communication function of the specific communication terminal is partially restricted as compared with a normal communication terminal that is not the specific communication terminal.

12. A terminal program that is a computer-readable terminal program for causing a computer to operate, in a communication terminal, as a terminal controller for controlling a terminal communicator performing radio communication with a base station, wherein
the terminal controller
causes the terminal communicator to transmit a first message of the radio communication to the base station without including, in the first message, specific terminal information indicating that the communication terminal is a specific communication terminal use of which is possibly restricted by the base station,
receives a second message as a response to the first message from the base station via the terminal communicator, and
includes the specific terminal information in a subsequent message that is or is subsequent to a third message as a response to the second message and causes the terminal communicator to transmit the subsequent message to the base station.

13. A base program that is a computer-readable base program for causing a computer to operate, in a base station, as a base controller for controlling a base communicator performing radio communication with a communication terminal, wherein
the base controller
receives a first message of the radio communication from the communication terminal via the base communicator,
causes the base communicator to transmit a second message to the communication terminal as a response to the first message in a case that the first message does not include specific terminal information indicating that the communication terminal is a specific communication terminal use of which is possibly restricted by the base station,
receives, from the communication terminal, a subsequent message that is a third message or is a message subsequent to the third message as a response to the second message, and
causes the communication terminal to use a communication function as the specific communication terminal in a case that the specific terminal information is included in the subsequent message.

14. A communication system comprising:
a communication terminal; and
a base station configured to perform radio communication with the communication terminal, wherein
the communication terminal transmits a first message of the radio communication to the base station without including, in the first message, specific terminal information indicating that the communication terminal is a specific communication terminal use of which is possibly restricted by the base station,
the base station receives the first message from the communication terminal and transmits a second message to the communication terminal as a response to the first message,
the communication terminal receives the second message from the base station, includes the specific terminal information in a subsequent message that is a third message or is a message subsequent to the third message as a response to the second message, and transmits the subsequent message to the base station, and
the base station receives the subsequent message from the communication terminal and causes the communication terminal to use a communication function as the specific communication terminal in a case that the specific terminal information is included in the subsequent message.

15. A communication method used between a communication terminal and a base station performing radio communication with the communication terminal, wherein
the communication terminal transmits a first message of the radio communication to the base station without including, in the first message, specific terminal information indicating that the communication terminal is a specific communication terminal use of which is possibly restricted by the base station,
the base station receives the first message from the communication terminal and transmits a second message to the communication terminal as a response to the first message,
the communication terminal receives the second message from the base station, includes the specific terminal information in a subsequent message that is a third message or is a message subsequent to the third message as a response to the second message, and transmits the subsequent message to the base station, and
the base station receives the subsequent message from the communication terminal and causes the communication terminal to use a communication function as the specific communication terminal in a case that the specific terminal information is included in the subsequent message.
